(19) United States
(12) Patent Application Publication
(10) Pub. No.: US 2017/0123301 A1
(43) Pub. Date: May 4, 2017

(54) LIGHT SOURCE APPARATUS AND IMAGE PROJECTION APPARATUS

(71) Applicant: USHIO DENKI KABUSHIKI KAISHA, Tokyo (JP)

(72) Inventor: Yuichi MIURA, Himeji-shi (JP)

(73) Assignee: USHIO DENKI KABUSHIKI KAISHA, Tokyo (JP)

(21) Appl. No.: 15/128,786

(22) PCT Filed: Mar. 6, 2015
(86) PCT No.: PCT/JP2015/056587

§ 371 Date: Sep. 23, 2016

(30) Foreign Application Priority Data
Mar. 27, 2014 (JP) 2014-065920

(51) Int. Cl. G03B 21/20; G01J 1/04

(52) U.S. Cl. CPC G03B 21/2053; G03B 21/208; G01J 1/0425; G03B 21/2013

(57) ABSTRACT

A light source apparatus, which includes a plurality of light sources which emit laser beams, a rod integrator in which the laser beams emitted from the plurality of light sources enter a first surface, and a light detecting part which detects reflected light reflected by a second surface of the rod integrator and emitted from the first surface of the rod integrator.

### TECHNICAL FIELD

The present invention relates to a light source apparatus equipped with a plurality of light sources which emit laser beams and a light detecting part which detects light. The present invention further relates to an image projection apparatus equipped with the light source apparatus.

### BACKGROUND ART

In the prior art, a light source apparatus equipped with a light source which emits a laser beam and a light detecting part which detects light has been known (for example, Patent Document 1). According to such a light source apparatus, since the light detecting part can detect a portion of the laser beam emitted from the light source, an output state of the light source can be detected.

In the light source apparatus according to Patent Document 1, the light detecting part is disposed on an optical path of the laser beam emitted from the light source, and a laser beam other than that in a backbone system (a system actually used as an apparatus) is detected; therefore, the disposition of the light detecting part cannot flexibly respond. Accordingly, in a light source apparatus having a plurality of light sources, since only the output states of one or two specific light sources can be detected, the output state as the entire light source cannot be accurately detected.

### PRIOR ART DOCUMENTS

### Patent Document

Patent Document 1: JP-A-2003-228868

### DISCLOSURE OF THE INVENTION

### Problems to be Solved by the Invention

In view of such circumstances, an object of the present invention is to provide a light source apparatus and an image projection apparatus which can accurately detect output states of a plurality of light sources.

### Means for Solving the Problems

According to the present invention, there is provided a light source apparatus, which includes:

a plurality of light sources which emit laser beams;

a rod integrator in which the laser beams emitted from the plurality of light sources enter a first surface; and

a light detecting part which detects reflected light reflected by a second surface of the rod integrator and emitted from the first surface of the rod integrator.

According to the light source apparatus of the present invention, light beams emitted from a plurality of light sources enter the first surface of the rod integrator, and a portion of the light beam is reflected by a second surface of the rod integrator. Then, the reflected light is emitted from the first surface of the rod integrator, and the light detecting part detects the reflected light.

Consequently, since the light detected by the light detecting part reciprocates in the rod integrator, light intensity is further uniformized. Accordingly, since the light detecting part can comprehensively detect both light emitted from a specific light source and light emitted from the plurality of light sources, the output states of the plurality of light sources can be accurately detected.

Also, the light source apparatus may have further:

a detection optical fiber in which the reflected light emitted from the first surface of the rod integrator enters an incident surface, and the reflected light is emitted from an exit surface toward the light detecting part; and

an imaging optical system which forms an image of the first surface of the rod integrator on the incident surface of the detection optical fiber.

According to such a constitution, the reflected light reflected by the second surface of the rod integrator and emitted from the first surface of the rod integrator enters from an incident surface of a detection optical fiber, and the light emitted from an exit surface of the detection optical fiber travels toward the light detecting part. Then, an imaging optical system forms an image of the first surface of the rod integrator on the incident surface of the detection optical fiber.

Consequently, in the state of light on the incident surface of the detection optical fiber, the state of the first surface of the rod integrator in which light intensity is uniformized can be maintained. Accordingly, since the light detecting part can more comprehensively detect light emitted from the plurality of light sources, the output states of the plurality of light sources can be more accurately detected.

Also, the light source apparatus may have further:

a light source optical fiber in which light emitted from the light source enters an incident surface, and light is emitted from an exit surface toward the first surface of the rod integrator through the imaging optical system,

wherein the exit surface of the light source optical fiber and the incident surface of the detection optical fiber are arranged to be on the same plane as each other so that the imaging optical system forms an image of the exit surface of the light source optical fiber on the first surface of the rod integrator.

According to such a constitution, the light emitted from the light source enters the incident surface of the light source optical fiber, and the light emitted from the exit surface of the light source optical fiber travels toward the first surface of the rod integrator through the imaging optical system. The exit surface of the light source optical fiber and the incident surface of the detection optical fiber are arranged to be on the same plane as each other.

Consequently, the imaging optical system forms the image of the exit surface of the light source optical fiber on the first surface of the rod integrator. Accordingly, the imaging optical system has not only a function of forming an image of the first surface of the rod integrator on the incident surface of the detection optical fiber but also a function of forming the image of the exit surface of the light source optical fiber on the first surface of the rod integrator.

In addition, uneven light (corresponding to light that could not enter inside the rod integrator) emitted from the exit surface of the light source optical fiber and reflected by the first surface of the rod integrator can be prevented from entering the incident surface of the detection optical fiber. Accordingly, since the light detecting part can accurately detect light emitted from the plurality of light sources, the output states of the plurality of light sources can be more accurately detected.

Also, the light source apparatus may have further:

a detection optical fiber in which the reflected light emitted from the first surface of the rod integrator enters from an incident surface and is emitted from an exit surface toward the light detecting part,

wherein the detection optical fiber is disposed such that the incident surface is abutted against or is close to the first surface of the rod integrator.

According to such a constitution, the reflected light reflected by the second surface of the rod integrator and emitted from the first surface of the rod integrator enters from an incident surface of a detection optical fiber, and the reflected light emitted from the exit surface of the detection optical fiber travels toward the light detecting part. The incident surface of the detection optical fiber is abutted against or is close to the first surface of the rod integrator.

Consequently, in the state of light on the incident surface of the detection optical fiber, the state of the first surface of the rod integrator in which light intensity is uniformized can be maintained. Accordingly, since the light detecting part can more comprehensively detect light emitted from the plurality of light sources, the output states of the plurality of light sources can be more accurately detected.

Also, the light source apparatus may have further:

a light source optical fiber in which light emitted from the light source enters an incident surface, and light is emitted from an exit surface toward the first surface of the rod integrator,

wherein the exit surface of the light source optical fiber and the incident surface of the detection optical fiber are arranged to be on the same plane as each other so that the exit surface of the light source optical fiber is abutted against or is close to the first surface of the rod integrator.

According to such a constitution, the light emitted from the light source enters from the incident surface of the light source optical fiber, and the light emitted from the exit surface of the light source optical fiber travels toward the first surface of the rod integrator. The exit surface of the light source optical fiber and the incident surface of the detection optical fiber are arranged to be on the same plane as each other. Consequently, the light emitted from the exit surface of the light source optical fiber efficiently enters the first surface of the rod integrator.

In addition, uneven light (corresponding to light that could not enter inside the rod integrator) emitted from the exit surface of the light source optical fiber and reflected by the first surface of the rod integrator can be prevented from entering the incident surface of the detection optical fiber. Accordingly, since the light detecting part can accurately detect light emitted from the plurality of light sources, the output states of the plurality of light sources can be more accurately detected.

Also, the light source apparatus may have further:

a plurality of light source units which have the light sources and emit light beams having different wavelengths; and

a synthesis/separation optical system which synthesizes the light beams emitted from the plurality of light source units to allow the light beams to enter the first surface of the rod integrator, and, thus, to separate the reflected light, emitted from the first surface of the rod integrator, for each wavelength of light emitted from each of the light source units,

wherein a plurality of the light detecting parts are equipped so as to detect each light separated by the synthesis/separation optical system.

According to such a constitution, the plurality of light source units each have a light source and emit light having different wavelengths. The synthesis/separation optical system synthesizes the light beams emitted from the plurality of light source units to allow the light beams to enter the first surface of the rod integrator and separates the reflected light, reflected by the second surface of the rod integrator and emitted from the first surface of the rod integrator, for each wavelength of light emitted from each of the light source units.

The plurality of light detecting parts detect light separated by the synthesis/separation optical system. Consequently, while a single rod integrator is shared, the output states of the plurality of light source units can be detected.

According to the present invention, there is provided an image projection apparatus, which includes at least one the light source apparatuses and using light, transmitting through the second surface of the rod integrator, as projected light.

According to an image projection apparatus of the present invention, light emitted from the light source apparatus enters the first surface of the rod integrator, and light transmitting through the second surface of the rod integrator is used as projected light. Consequently, the rod integrator has both a function of uniformizing the light intensity of light detected by the light detecting part and a function of uniformizing the light intensity of the light used as the projected light.

### Effect of the Invention

As described above, the present invention provides an excellent effect that the output states of a plurality of light sources can be accurately detected.

### BRIEF DESCRIPTION OF THE DRAWINGS

FIG. 1 is an overall schematic diagram of an image projection apparatus according to one embodiment of the present invention.

FIG. 2 is a schematic diagram of a relevant portion of a light source apparatus according to the same embodiment and is a view showing a condition of light in a backbone system.

FIG. 3 is a schematic diagram of a relevant portion of the light source apparatus according to the same embodiment and is a view showing a condition of detection light.

FIG. 4 is a view showing an image of light reflected by a first surface of a rod integrator according to the same embodiment.

FIG. 5 is a view showing an image in the first surface of light reflected by a second surface of the rod integrator according to the same embodiment.

FIG. 6 is a schematic diagram of a relevant portion of a light source apparatus according to another embodiment of the present invention and is a view showing a condition of light in a backbone system.

FIG. 7 is a schematic diagram of a relevant portion of the light source apparatus according to the same embodiment and is a view showing a condition of detection light.

FIG. 8 is an overall schematic diagram of an image projection apparatus according to yet another embodiment of the present invention.

FIG. 9 is a schematic diagram of a relevant portion of a light source apparatus according to the same embodiment.

### MODE FOR CARRYING OUT THE INVENTION

### First Embodiment

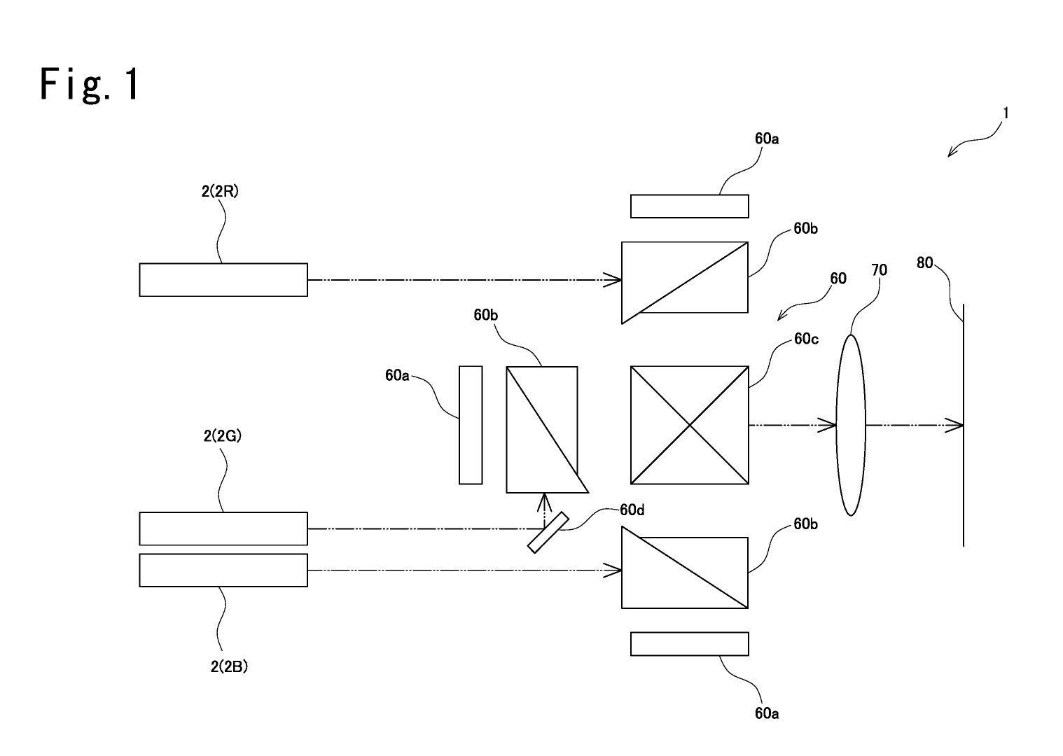

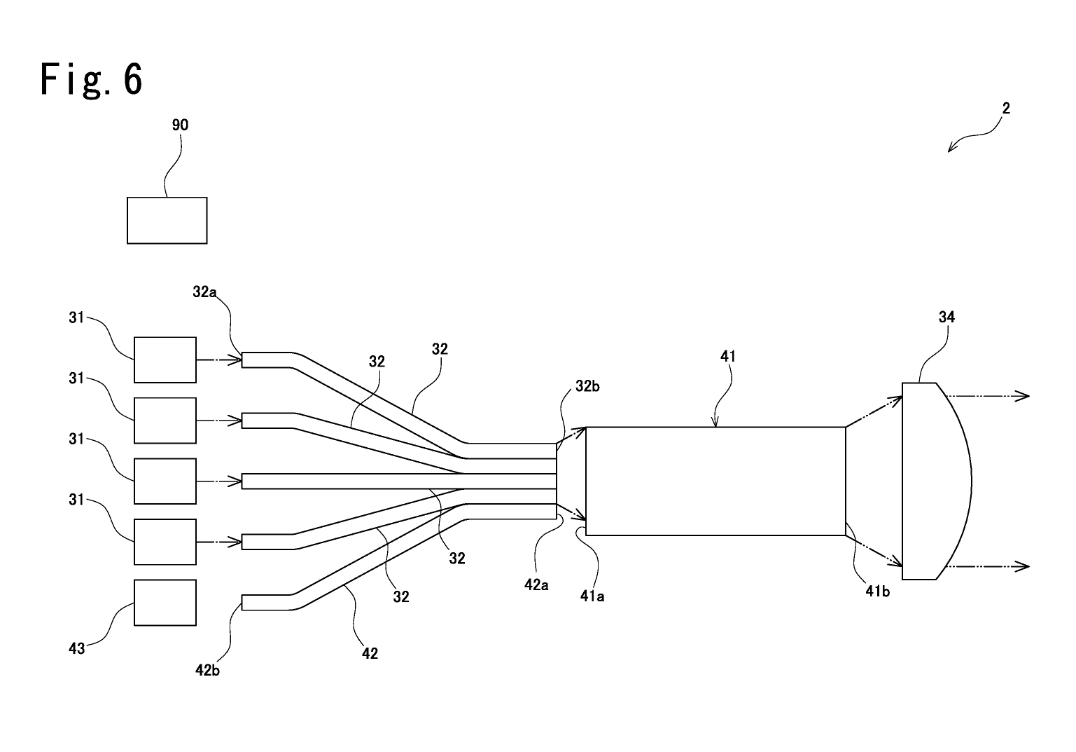

Hereinafter, a first embodiment of the light source apparatus and the image projection apparatus of the present invention will be described with reference to FIGS. 1 to 5. Here, in each drawing (the same applies to FIGS. 6 to 9), the dimensional ratio of the drawings does not necessarily coincide with the actual dimensional ratio.

As shown in FIG. 1, an image projection apparatus 1 according to the present embodiment is equipped with a plurality of (three in this embodiment) light source apparatuses 2 (2R, 2G, and 2B) which emit light beams in different colors. The image projection apparatus 1 is further equipped with an image optical system 60, which allows incidence of the laser beam emitted from the light source apparatus 2 to generate an optical image, and a projection optical system (for example, a projection lens) 70 which allows incidence of the optical image emitted from the image optical system 60 to project the optical image onto a screen 80.

The first light source apparatus 2R emits light in a first color (for example, red), the second light source apparatus 2G emits light in a second color (for example, green), and the third light source apparatus 2B emits light in a third color (for example, blue). Namely, the light source apparatuses 2R, 2G, and 2B emit light beams having different wavelengths.

The image optical system 60 is equipped with a spatial modulation element 60a which modulates light emitted from the light source apparatus 2 to form an optical image, a total reflection prism 60b, and a dichroic prism 60c. The image optical system 60 is further equipped with a reflecting mirror 60d which reflects a laser beam emitted from the second light source apparatus 2G. In this embodiment, each of the spatial modulation elements 60a is a digital micromirror device. The image optical system 60 may be equipped with the spatial modulation element 60a which is a transmission or reflection type liquid crystal element.

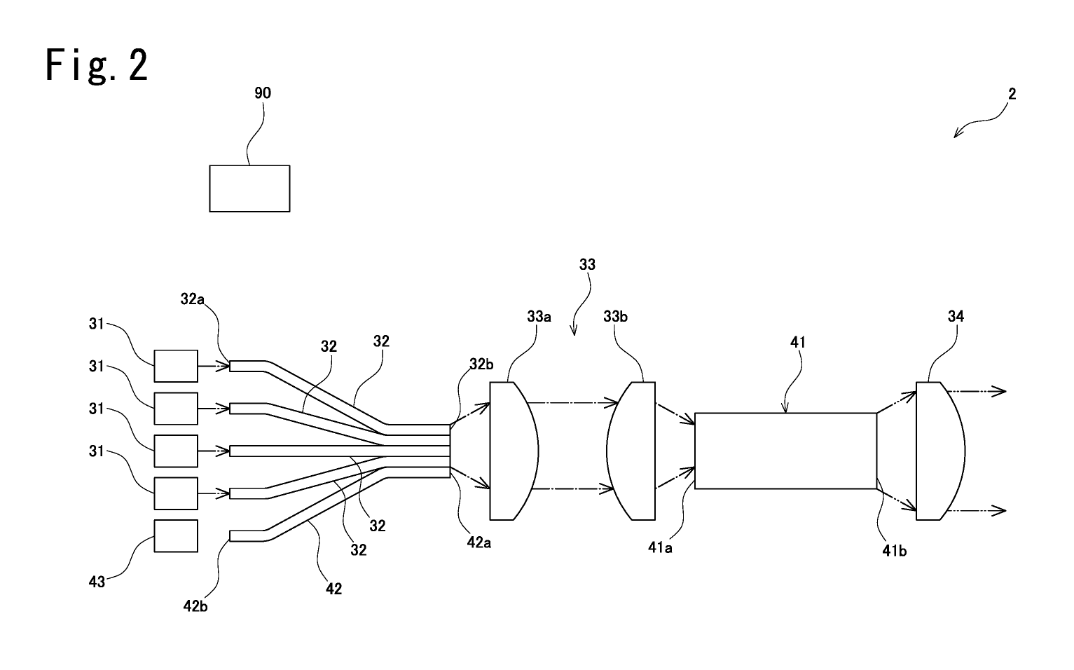

As shown in FIG. 2, the light source apparatus 2 is equipped with a plurality of (four in FIG. 2) light sources 31 which emit laser beams and a plurality of (four in FIG. 2) light source optical fibers 32 to which the laser beam emitted from each of the light sources 31 enters from an incident surface 32a. The light source apparatus 2 is further equipped with an imaging optical system 33 to which light emitted from an exit surface 32b of each of the light source optical fibers 32 enters.

The light source apparatus 2 is equipped with a rod integrator 41 to which light emitted from the imaging optical system 33 enters from a first surface 41a and an image forming lens 34 to which light emitted from a second surface 41b of the rod integrator 41 enters. The light source apparatus 2 is further equipped with a detection optical fiber 42 to which reflected light reflected by the second surface 41b of the rod integrator 41 and emitted from the first surface 41a of the rod integrator 41 enters from an incident surface 42a through the imaging optical system 33. Hereinafter, the “reflected light” indicates only light reflected by the second surface 41b of the rod integrator 41.

The light source apparatus 2 is equipped with a light detecting part 43 which detects the reflected light emitted from an exit surface 42b of the detection optical fiber 42. In FIG. 2, a chain line shows light emitted from the light source 31 and entering the first surface 41a of the rod integrator 41, and a two-dot chain line shows light transmitting through the second surface 41b of the rod integrator 41.

Although not illustrated, each of the light sources 31 is equipped with at least one semiconductor laser which emits a laser beam. Each of the light sources 31 may be further equipped with a lens for allowing the laser beam emitted from the semiconductor laser to efficiently enter the light source optical fiber 32.

The exit surfaces 32b of the light source optical fibers 32 and the incident surface 42a of the detection optical fiber 42 are arranged to be on the same plane as each other. Namely, the exit surfaces 32b of the light source optical fibers 32 and the incident surface 42a of the detection optical fiber 42 are arranged on the same plane. For example, the exit surface 32b side of the light source optical fibers 32 and the incident surface 42a side of the detection optical fiber 42 are held by a holding member (not shown) while being bundled together. This is a so-called bundle structure.

The imaging optical system 33 is equipped with a collimator lens 33a through which light emitted from the light source optical fiber 32 enters. The imaging optical system 33 is further equipped with a converging lens 33b through which light emitted from the collimator lens 33a enters.

In the collimator lens 33a, light emitted from the light sources 31 and diverging through the light source optical fiber 32 enters thereto, and the collimator lens 33a converges the light into parallel light to emit the parallel light toward the converging lens 33b. In the converging lens 33b, the light emitted from the collimator lens 33a enters thereto, and the converging lens 33b converges the light to emit the light toward the rod integrator 41. Consequently, the imaging optical system 33 forms an image of the exit surface 32b of the light source optical fiber 32 on the first surface 41a of the rod integrator 41.

The rod integrator 41 is formed of optical glass, and the first surface 41a and the second surface 41b of the rod integrator 41 are each formed in a planar shape. The first surface 41a of the rod integrator 41 is disposed parallel to the exit surface 32b of the light source optical fiber 32 and the incident surface 42a of the detection optical fiber 42.

In the rod integrator 41, in order to equalize the illuminance of the second surface 41b, light intensity of light entering from the first surface 41a is uniformized, and the light is emitted from the second surface 41b. The image forming lens 34 forms an image of the second surface 41b of the rod integrator 41 on the incident surface of the spatial modulation element 60a of the image optical system 60.

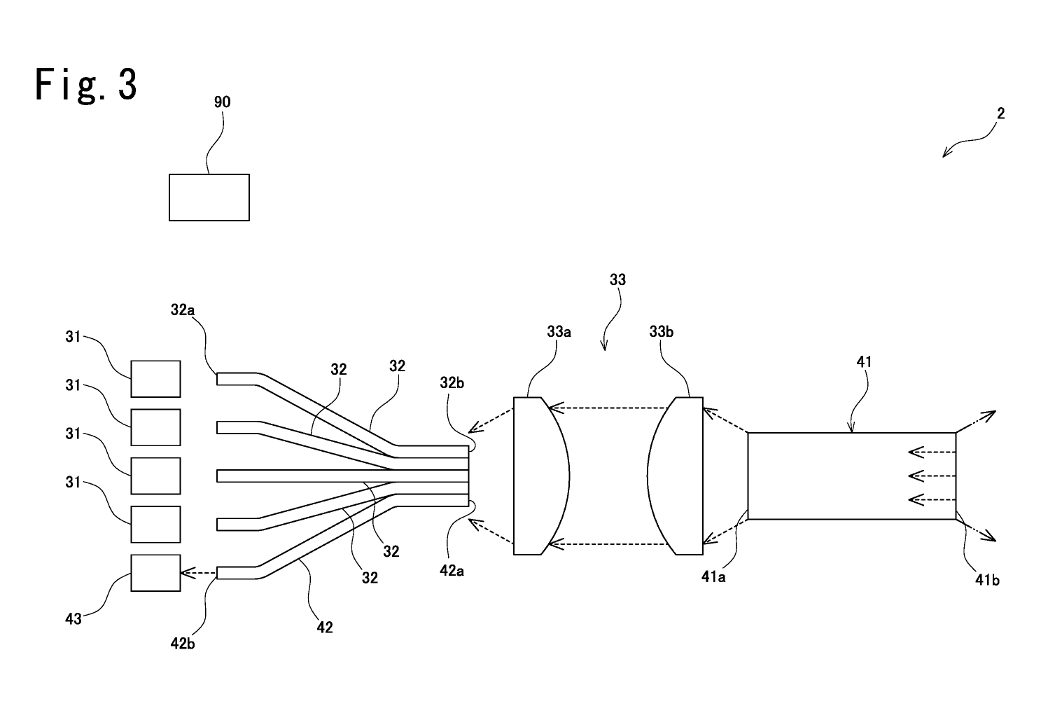

As shown in FIG. 3, since the rod integrator 41 has a refractive index different from that of air, a portion of light (for example, 1%) entering from the first surface 41a is reflected by the second surface 41b. In FIG. 3, a two-dot chain line shows light transmitting through the second surface 41b of the rod integrator 41, and a dashed line shows the reflected light reflected by the second surface 41b of the rod integrator 41. The rod integrator 41 allows the reflected light, reflected by the second surface 41b, to emit from the first surface 41a.

In the converging lens 33b, the reflected light emitted from the first surface 41a of the rod integrator 41 enters thereto to be converted into parallel light, and, thus, to be emitted toward the collimator lens 33a. In the collimator lens 33a, the parallel reflected light emitted from the converging lens 33b enters thereto to be converged, and, thus, to be emitted toward the incident surface 42a of the detection optical fiber 42. According to this constitution, the imaging optical system 33 forms an image in a predetermined region of the first surface 41a of the rod integrator 41 on the incident surface 42a of the detection optical fiber 42.

The light detecting part 43 is an optical sensor which measures an amount of light. The light detecting part 43 receives the reflected light emitted from the exit surface 42b of the detection optical fiber 42. If necessary, the light detecting part 43 may be equipped with a lens for allowing the reflected light, emitted from the exit surface 42b of the detection optical fiber 42, to efficiently enter the optical sensor.

As described above, the light transmitting through the second surface 41b of the rod integrator 41 is emitted from the light source apparatus 2 and used as projected light (light in a backbone system) of the image projection apparatus 1. The reflected light reflected by the second surface 41b of the rod integrator 41 is detected by the light detecting part 43 and used as detection light for detecting output states of the light sources 31. A controller 90 controls the output of the light source 31 by, for example, an electric power (current and voltage) or the like supplied to the light source 31, based on the amount of light detected by the light detecting part 43.

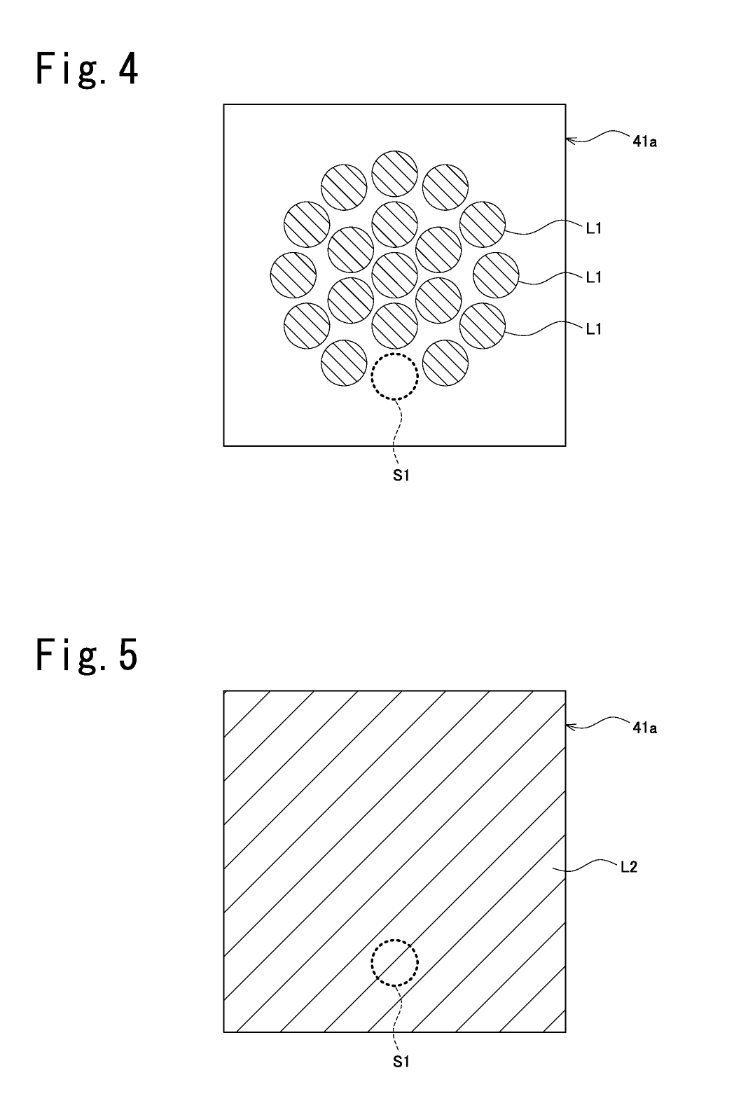

Here, the operation of the imaging optical system 33 will be described with reference to FIGS. 4 and 5. There will be described a case where while eighteen light source optical fibers 32 each having the circular exit surface 32b are equipped, one detection optical fiber 42 having the circular incident surface 42a is equipped, and the first surface 41a of the rod integrator 41 has a square shape.

The refractive index (N−1.5) of the rod integrator 41 formed of optical glass is different from the refractive index (N=1.0) of air. Accordingly, when light enters the first surface 41a of the rod integrator 41, a portion of the light is reflected by the first surface 41a. Meanwhile, when light transmits through the second surface 41b of the rod integrator 41, a portion of the light is reflected by the second surface 41b. A reflectance of the first surface 41a of the rod integrator 41 is substantially the same as a reflectance of the second surface 41b of the rod integrator 41.

The imaging optical system 33 forms an image in a predetermined region of the first surface 41a of the rod integrator 41 on the incident surface 42a of the detection optical fiber 42. Accordingly, as shown in FIGS. 4 and 5, light in a predetermined region S1 of the first surface 41a of the rod integrator 41 enters the incident surface 42a of the detection optical fiber 42.

The imaging optical system 33 forms an image of the exit surface 32b of the light source optical fiber 32 on the first surface 41a of the rod integrator 41. Accordingly, an image of light L1 emitted from the imaging optical system 33 and entering the first surface 41a of the rod integrator 41 has the same (or similar) shape to disposition of the exit surface 32b of the light source optical fiber 32, as shown in FIG. 4. In FIG. 4, diagonal lines show the image of the light L1.

An image of the light L1 reflected by the first surface 41a of the rod integrator 41 is the same as the image of the light L1 entering the first surface 41a of the rod integrator 41. According to this constitution, since the light L1 reflected by the first surface 41a of the rod integrator 41 does not exist in the predetermined region S1, the light L1 reflected by the first surface 41a of the rod integrator 41 is prevented from entering the incident surface 42a of the detection optical fiber 42 through the imaging optical system 33.

The reflected light reflected by the second surface 41b of the rod integrator 41 is uniformized by the rod integrator 41 to be emitted from the first surface 41a. Accordingly, an image of reflected light L2 in which the reflected light is emitted from the first surface 41a of the rod integrator 41 has the same shape as the first surface 41a. In FIG. 5, a diagonal portion is the image of the reflected light L2.

As described above, the imaging optical system 33 prevents light reflected by the first surface 41a of the rod integrator 41, that is, light that is not uniformized from entering the detection optical fiber 42 and allows the reflected light reflected by the second surface 41b of the rod integrator 41, that is, the uniformized reflected light to enter the detection optical fiber 42. Accordingly, the light detecting part 43 can accurately detect light emitted from the light sources 31.

Thus, according to the light source apparatus 2 of this embodiment, the light beams emitted from the light sources 31 enter the first surface 41a of the rod integrator 41, and a portion of the light is reflected by the second surface 41b of the rod integrator 41. The reflected light is emitted from the first surface 41a of the rod integrator 41, and the light detecting part 43 detects a portion of the reflected light.

According to the above constitution, since the reflected light detected by the light detecting part 43 reciprocates in the rod integrator 41, the light intensity is further uniformized. Accordingly, since the light detecting part 43 can comprehensively detect not only light emitted from the specific light source 31 but also light emitted from the light sources 31, the output states of the light sources 31 can be accurately detected.

According to the light source apparatus 2 of this embodiment, a portion of the reflected light reflected by the second surface 41b of the rod integrator 41 and emitted from the first surface 41a of the rod integrator 41 enters the incident surface 42a of the detection optical fiber 42, and the reflected light emitted from the exit surface 42b of the detection optical fiber 42 travels toward the light detecting part 43. The imaging optical system 33 forms an image in the predetermined region S1 of the first surface 41a of the rod integrator 41 on the incident surface 42a of the detection optical fiber 42.

According to the above constitution, the state of the light on the incident surface 42a of the detection optical fiber 42 can maintain the state of the first surface 41a of the rod integrator 41 in which the light intensity is uniformized. Accordingly, since the light detecting part 43 can comprehensively detect the light emitted from the light sources 31, the output states of the light sources 31 can be more accurately detected.

Further, according to the light source apparatus 2 of this embodiment, the light emitted from the light source 31 enters the incident surface 32a of the light source optical fiber 32, and light emitted from the exit surface 32b of the light source optical fiber 32 travels toward the first surface 41a of the rod integrator 41 through the imaging optical system 33. The exit surface 32b of the light source optical fiber 32 and the incident surface 42a of the detection optical fiber 42 are arranged to be on the same plane as each other.

According to the above constitution, the imaging optical system 33 forms an image of the exit surface 32b of the light source optical fiber 32 on the first surface 41a of the rod integrator 41. Accordingly, the imaging optical system 33 has not only a function of forming the image in the predetermined region S1 of the first surface 41a of the rod integrator 41 on the incident surface 42a of the detection optical fiber 42 but also a function of forming the image of the exit surface 32b of the light source optical fiber 32 on the first surface 41a of the rod integrator 41.

In addition, uneven light (corresponding to light that could not enter inside the rod integrator 41) emitted from the exit surface 32b of the light source optical fiber 32 and reflected by the first surface 41a of the rod integrator 41 can be prevented from entering the incident surface 42a of the detection optical fiber 42. Accordingly, since the light detecting part 43 can accurately detect light emitted from the light sources 31, the output states of the light sources 31 can be more accurately detected.

Further, according to the image projection apparatus 1 of this embodiment, the light emitted from the light source apparatus 2 enters the first surface 41a of the rod integrator 41, and light transmitting through the second surface 41b of the rod integrator 41 is used as projected light. Consequently, the rod integrator 41 has both a function of uniformizing the light intensity of light detected by the light detecting part 43 and a function of uniformizing the light intensity of the light used as the projected light.

Furthermore, according to the image projection apparatus 1 of this embodiment, the light detecting part 43 detects the reflected light reflected by the second surface 41b of the rod integrator 41 required to uniformize the light intensity of the light used as the projected light. Namely, the light beams emitted from the light sources 31 are detected using light lost in the prior art, that is, light lost necessarily (light reducing light utilization efficiency). Consequently, the reduction in the light utilization efficiency (a ratio by which light emitted from the light source 31 is used as projected light) can be prevented.

### Second Embodiment

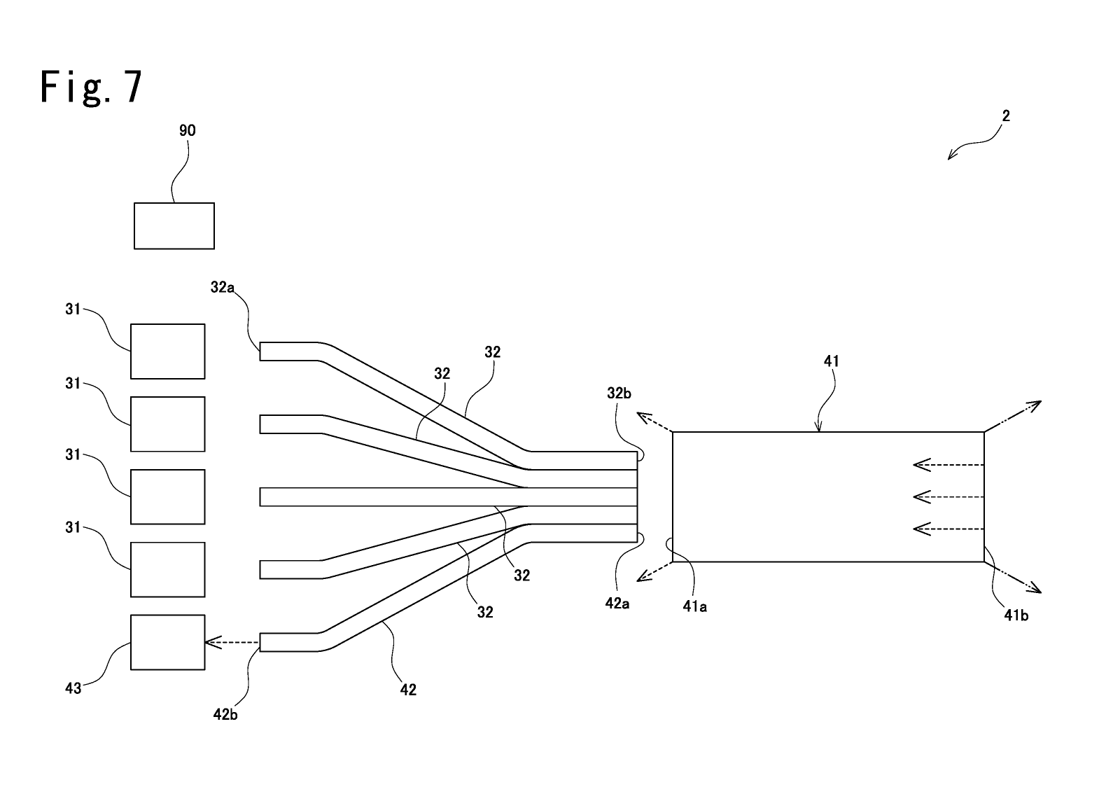

Next, a second embodiment of the light source apparatus and the image projection apparatus of the present invention will be described with reference to FIGS. 6 and 7. In FIGS. 6 and 7, parts designated by the same reference numerals as FIGS. 1 to 5 represent configurations or components similar to those of the first embodiment, and thus, their descriptions are not repeated.

The light source apparatus 2 of this embodiment differs from the light source apparatus 2 of the first embodiment in that the imaging optical system 33 is not equipped and in arrangement of each of the optical fibers 32 and 42 and the rod integrator 41. Accordingly, the arrangement of each of the optical fibers 32 and 42 and the rod integrator 41 will be described.

As shown in FIG. 6, exit surfaces 32b of the light source optical fibers 32 and an incident surface 42a of the detection optical fiber 42 are arranged to be on the same plane as each other. The exit surfaces 32b of the light source optical fibers 32 and the incident surface 42a of the detection optical fiber 42 are arranged close to a first surface 41a of the rod integrator 41 (with slight spacing between them).

The first surface 41a of the rod integrator 41 is disposed in parallel so as to face the exit surface 32b of the light source optical fiber 32 and the incident surface 42a of the detection optical fiber 42. The exit surface 32b of the light source optical fiber 32 and the incident surface 42a of the detection optical fiber 42 may be arranged abutted against the first surface 41a of the rod integrator 41.

In FIG. 6, a chain line shows light emitted from the light source 31 and entering the first surface 41a of the rod integrator 41, and a two-dot chain line shows light transmitting through the second surface 41b of the rod integrator 41. In FIG. 7, a two-dot chain line shows light transmitting through the second surface 41b of the rod integrator 41, and a dashed line shows reflected light reflected by the second surface 41b of the rod integrator 41.

Thus, according to the light source apparatus 2 of this embodiment, a portion of the reflected light reflected by the second surface 41b of the rod integrator 41 and emitted from the first surface 41a of the rod integrator 41 enters the incident surface 42a of the detection optical fiber 42, and the reflected light emitted from the exit surface 42b of the detection optical fiber 42 travels toward a light detecting part 43. The incident surface 42a of the detection optical fiber 42 is close to (or is abutted against) the first surface 41a of the rod integrator 41.

Consequently, in the state of light on the incident surface 42a of the detection optical fiber 42, the state of the first surface 41a of the rod integrator 41 in which the light intensity is uniformized can be maintained. Accordingly, since the light detecting part 43 can more comprehensively detect light emitted from the light sources 31, the output states of the light sources 31 can be more accurately detected.

Further, according to the light source apparatus 2 of this embodiment, the light emitted from the light source 31 enters the incident surface 32a of the light source optical fiber 32, and light emitted from the exit surface 32b of the light source optical fiber 32 travels toward the first surface 41a of the rod integrator 41. The exit surface 32b of the light source optical fiber 32 and the incident surface 42a of the detection optical fiber 42 are arranged to be on the same plane as each other. Consequently, the light emitted from the exit surface 32b of the light source optical fiber 32 efficiently enters the first surface 41a of the rod integrator 41.

In addition, uneven light (corresponding to light that could not enter inside the rod integrator 41) emitted from the exit surface 32b of the light source optical fiber 32 and reflected by the first surface 41a of the rod integrator 41 can be prevented from entering the incident surface 42a of the detection optical fiber 42. Accordingly, since the light detecting part 43 can accurately detect the light emitted from the light sources 31, the output states of the light sources 31 can be more accurately detected.

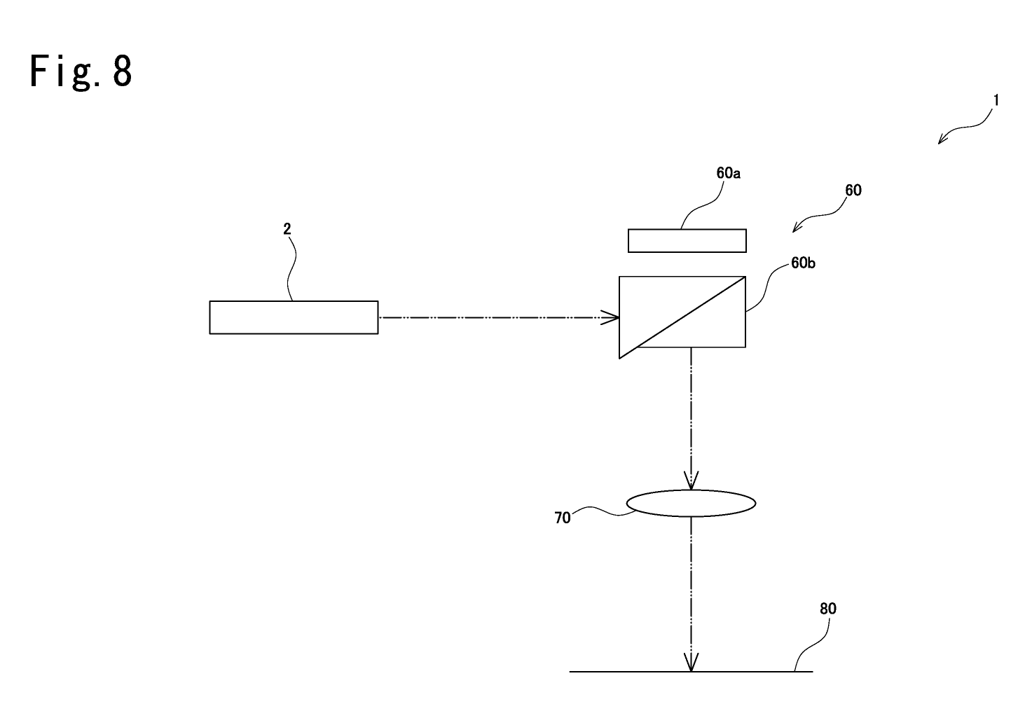

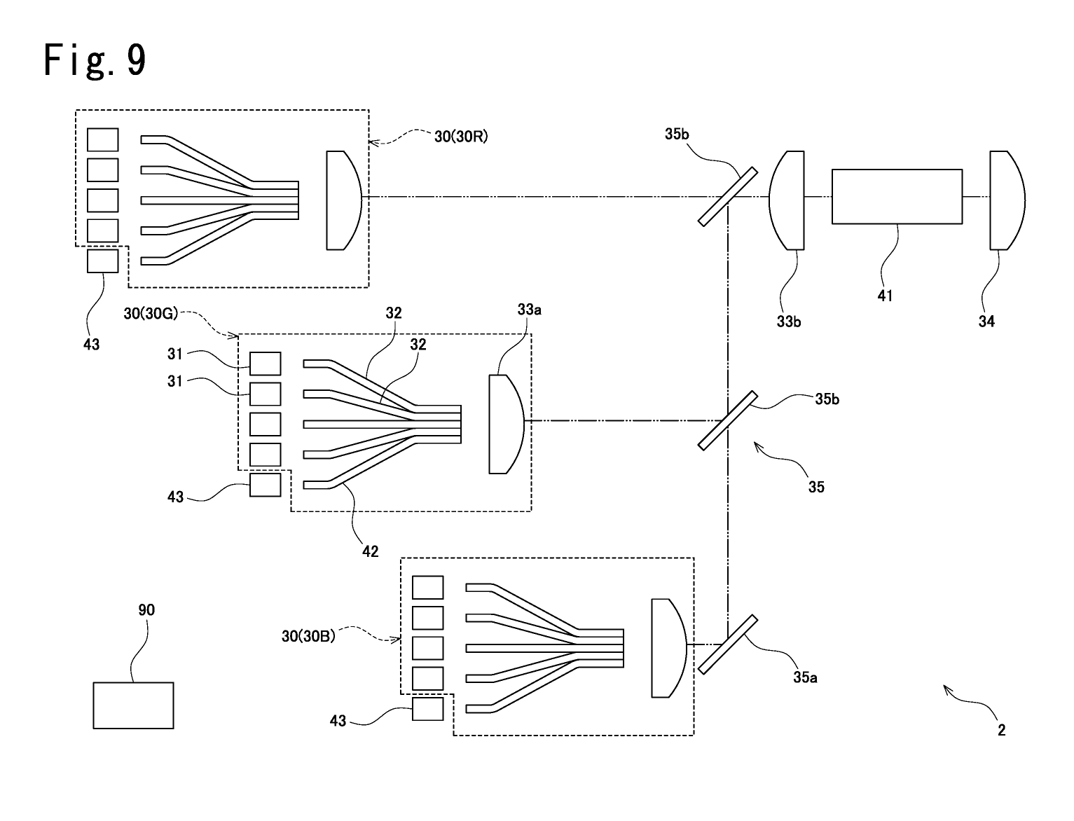

Next, a third embodiment of the light source apparatus and the image projection apparatus of the present invention will be described with reference to FIGS. 8 and 9. In FIGS. 8 and 9, parts designated by the same reference numerals as FIGS. 1 to 5 represent configurations or components similar to those of the first embodiment, and thus, their descriptions are not repeated.

As shown in FIG. 8, an image projection apparatus 1 of this embodiment is equipped with a light source apparatus 2 which repeatedly emits light beams in different colors (such as red, green, and blue) in order. The image projection apparatus 1 is further equipped with an image optical system 60 and a projection optical system 70.

In this embodiment, a spatial modulation element 60a is synchronized with the light source apparatus 2 to form an image in each color. The image optical system 60 may be configured to color-separate the light to form an image in each color with the spatial modulation elements 60a and then synthesize colors again. In such a configuration, the light source apparatus 2 may simultaneously emit light beams in different colors.

As shown in FIG. 9, the light source apparatus 2 is equipped with, for each color (wavelength), a plurality of light sources 31, a plurality of light source optical fibers 32, a collimator lens 33a, a detection optical fiber 42, and a light detecting part 43. A configuration having the light sources 31, the light source optical fiber 32, the collimator lens 33a, and the detection optical fiber 42 is referred to as a light source unit 30.

The plurality of (three in this embodiment) light source units 30 emit light beams in different colors (light beams having different wavelengths). A first light source unit 30R emits light in a first color (for example, red), a second light source unit 30G emits light in a second color (for example, green), and a third light source unit 30B emits light in a third color (for example, blue).

The light source apparatus 2 is equipped with a converging lens 33b, a rod integrator 41, and an image forming lens 34. The light source apparatus 2 is further equipped with a synthesis/separation optical system 35 which synthesizes and separates light beams. The synthesis/separation optical system 35 is equipped with a reflecting mirror 35a and a dichromic mirror 35b.

The synthesis/separation optical system 35 synthesizes the light beams emitted from the light source units 30 to allow the synthesized light to enter a first surface 41a of the rod integrator 41. Further, the synthesis/separation optical system 35 separates reflected light, reflected by a second surface 41b of the rod integrator 41 and emitted from the first surface 41a of the rod integrator 41, for each wavelength of light emitted from each of the light source units 30.

Thus, according to the image projection apparatus 1 of this embodiment, the light emitted from the light source apparatus 2 enters the first surface 41a of the rod integrator 41, and light transmitting through the second surface 41b of the rod integrator 41 is used as projected light. Consequently, the rod integrator 41 has both a function uniformizing the light intensity of light detected by the light detecting part 43 and a function of uniformizing the light intensity of the light used as the projected light.

With respect to the light source units 30, the converging lens 33b, the rod integrator 41, and the image forming lens 34 are made common. Accordingly, the apparatus can be simplified.

The present invention is not limited to the configurations of the embodiments and the advantages. Moreover, it should be understood that the various changes, substitutions, and alterations could be made hereto without departing from the spirit and scope of the invention. For example, the constituents, methods, and the like of the plurality of embodiments described above can be arbitrarily employed and combined (the constituents, methods, and the like of one embodiment can be applied to the constituents, methods, and the like of the other embodiments), and the constituents, methods, and the like of various modified examples described below may be arbitrarily selected and employed as the constituents, methods, and the like of the embodiments described above, as a matter of course.

In the light source apparatus 2 of this present invention, the second surface 41b of the rod integrator 41 may be equipped with a reflective portion such that a reflectance of the second surface 41b (a reflectance obtained when light transmits through the second surface 41b) is higher than a reflectance of the first surface 41a (a reflectance obtained when light enters the first surface 41a. Alternatively, the first surface 41a of the rod integrator 41 may be equipped with an anti-reflective portion such that the reflectance of the second surface 41b is higher than the reflectance of the first surface 41a.

It is preferable that, for example, the reflectance of the first surface 41a is generally about 1%, whereas the reflectance of the second surface 41b is about 4%. As an example, the first surface 41a is subjected to non-reflective coating (that is, an anti-reflective portion) with a dielectric multilayer film such that the reflectance is about 1%, as in the rod integrator 41 of the above embodiment, and the second surface 41b is constituted of a surface to which such coating is not applied (that is, a reflective portion) such that the reflectance is about 4%.

According to the above constitution, if the light reflected by the first surface 41a and the reflected light reflected by the second surface 41b are detected by the light detecting part 43, the light detecting part 43 can detect more reflected light reflected by the second surface 41b than the light reflected by the first surface 41a. Accordingly, since the influence of the light reflected by the first surface 41a can be reduced, detection accuracy for the output states of the light sources 31 can be enhanced.

Further, in the light source apparatus 2 of the above embodiment, the light detecting part 43 is configured such that the reflected light reflected by the second surface 41b of the rod integrator 41 and emitted from the first surface 41a of the rod integrator 41 enters the light detecting part 43 through the detection optical fiber 42. However, the light source apparatus of the present invention is not limited to such a configuration.

Specifically, in the light source apparatus 2 of the present invention, the light detecting part 43 may be configured such that the reflected light reflected by the second surface 41b of the rod integrator 41 and emitted from the first surface 41a of the rod integrator 41 enters directly the light detecting part 43 or, for example, is close to or is abutted against the first surface 41a of the rod integrator 41. Further, the light detecting part 43 may be configured such that the reflected light reflected by the second surface 41b of the rod integrator 41 and emitted from the first surface 41a of the rod integrator 41 enters the light detecting part 43 through only the imaging optical system 33. Furthermore, the light detecting part 43 maybe configured such that the reflected light enters the light detecting part 43 through a lens or the like other than the imaging optical system 33.

Furthermore, in the light source apparatus 2 of the above embodiment, the light detecting part 43 is configured to detect a portion of the reflected light entering the detection optical fiber 42, of the reflected light reflected by the second surface 41b of the rod integrator 41 and emitted from the first surface 41a of the rod integrator 41. However, the light source apparatus of the present invention is not limited to such a configuration. For example, in the light source apparatus of the present invention, the light detecting part 43 may be configured to detect all the reflected light reflected by the second surface 41b of the rod integrator 41 and emitted from the first surface 41a of the rod integrator 41.

### DESCRIPTION OF REFERENCE SIGNS

1 . . . image projection apparatus, 2 . . . light source apparatus, 2R . . . first light source apparatus, 2G . . . second light source apparatus, 2B . . . third light source apparatus, 30 . . . light source unit, 30R . . . first light source unit, 30G . . . second light source unit, 30B . . . third light source unit, 31 . . . light source, 32 . . . light source optical fiber, 32a . . . incident surface, 32b . . . exit surface, 33 . . . imaging optical system, 33a . . . collimator lens, 33b . . . converging lens, 34 . . . image forming lens, 35 . . . synthesis/separation optical system, 35a . . . reflecting mirror, 35b . . . dichromic mirror, 41 . . . rod integrator, 41a . . . first surface, 41b . . . second surface, 42 . . . detection optical fiber, 42a . . . incident surface, 42b . . . exit surface, 43 . . . light detecting part, 60 . . . image optical system, 60a . . . spatial modulation element, 60b . . . total reflection prism, 60c . . . dichroic prism, 60d . . . reflecting mirror, 70 . . . projection optical system, 80 . . . screen, 90 . . . controller, L1 . . . light, L2 . . . light, and S1 . . . region

1. A light source apparatus, comprising:
a plurality of light sources which emit laser beams;
a rod integrator in which the laser beams emitted from the plurality of light sources enter a first surface; and
a light detecting part which detects reflected light reflected by a second surface of the rod integrator and emitted from the first surface of the rod integrator.

2. The light source apparatus according to claim 1, further comprising:
a detection optical fiber in which the reflected light emitted from the first surface of the rod integrator enters an incident surface, and the reflected light is emitted from an exit surface toward the light detecting part; and
an imaging optical system which forms an image of the first surface of the rod integrator on the incident surface of the detection optical fiber.

3. The light source apparatus according to claim 2, further comprising a light source optical fiber in which light emitted from the light source enters an incident surface, and light is emitted from an exit surface toward the first surface of the rod integrator through the imaging optical system,
wherein the exit surface of the light source optical fiber and the incident surface of the detection optical fiber are arranged to be on the same plane as each other so that the imaging optical system forms an image of the exit surface of the light source optical fiber on the first surface of the rod integrator.

4. The light source apparatus according to claim 1, further comprising a detection optical fiber in which the reflected light emitted from the first surface of the rod integrator enters from an incident surface and is emitted from an exit surface toward the light detecting part,
wherein the detection optical fiber is disposed such that the incident surface is abutted against or is close to the first surface of the rod integrator.

5. The light source apparatus according to claim 4, further comprising a light source optical fiber in which light emitted from the light source enters an incident surface, and light is emitted from an exit surface toward the first surface of the rod integrator,
wherein the exit surface of the light source optical fiber and the incident surface of the detection optical fiber are arranged to be on the same plane as each other so that the exit surface of the light source optical fiber is abutted against or is close to the first surface of the rod integrator.

6. The light source apparatus according to claim 1, further comprising:
a plurality of light source units which have the light sources and emit light beams having different wavelengths; and
a synthesis/separation optical system which synthesizes the light beams emitted from the plurality of light source units to allow the light beams to enter the first surface of the rod integrator, and, thus, to separate the reflected light, emitted from the first surface of the rod integrator, for each wavelength of light emitted from each of the light source units,
wherein a plurality of the light detecting parts are equipped so as to detect each light separated by the synthesis/separation optical system.

7. An image projection apparatus comprising at least one the light source apparatuses according to claim 1 and using light, transmitting through the second surface of the rod integrator, as projected light.
